(19) United States
(12) Patent Application Publication
(10) Pub. No.: US 2025/0125404 A1
(43) Pub. Date: Apr. 17, 2025

(54) LITHIUM ION BATTERY

(71) Applicant: TOYOTA JIDOSHA KABUSHIKI KAISHA, Aichi-ken (JP)

(72) Inventor: Akira KOHYAMA, Toyoake-shi (JP)

(21) Appl. No.: 18/882,751

(22) Filed: Sep. 12, 2024

(30) Foreign Application Priority Data
Oct. 11, 2023 (JP) 2023-175817

(51) Int. Cl. H01M 10/0525; H01M 4/02; H01M 4/62; H01M 10/0569

(52) U.S. Cl. CPC H01M 10/0525; H01M 4/624; H01M 10/0569; H01M 2004/028; H01M 2300/0037

(57) ABSTRACT

A lithium ion battery includes a positive electrode, a negative electrode, and an electrolyte solution. The positive electrode includes a positive electrode composite material. The positive electrode composite material includes a positive electrode active material and Li₃PO₄. The electrolyte solution includes a lithium salt and a solvent. The solvent includes 20% or more of the carboxylic acid ester in volume fraction.

### CROSS REFERENCE TO RELATED APPLICATIONS

This nonprovisional application is based on Japanese Patent Application No. 2023-175817 filed on Oct. 11, 2023 with the Japan Patent Office, the entire contents of which are hereby incorporated by reference.

### BACKGROUND

### Field

The present disclosure relates to a lithium ion battery.

### Description of the Background Art

JP 2019-050155A discloses an electrolyte solution that may contain esters.

### SUMMARY

In general, an electrolyte solution of a lithium ion battery (hereinafter, also simply referred to as a “battery”) includes a carbonate as a solvent. Carboxylic acid ester (CAE) can have a lower viscosity than that of the carbonate. When the CAE substitutes for a part of the carbonate, it is expected to, for example, improve input/output characteristics. However, the use of the CAE tends to cause decreased storage characteristics. Therefore, conventionally, it has been difficult to increase the volume fraction of the CAE in the solvent.

It is an object of the present disclosure to reduce decreased storage characteristics resulting from the use of carboxylic acid ester.

1. A lithium ion battery according to one aspect of the present disclosure has the following configuration. The lithium ion battery includes a positive electrode, a negative electrode, and an electrolyte solution. The positive electrode includes a positive electrode composite material. The positive electrode composite material includes a positive electrode active material and Li₃PO₄. The electrolyte solution includes a lithium salt and a solvent. The solvent includes 20% or more of a carboxylic acid ester in volume fraction.

Normally, as the volume fraction of the CAE in the electrolyte solution is increased, the storage characteristics tend to be decreased. The CAE tends to have a lower oxidation decomposition potential than that of a carbonate. It is considered that the decrease of the storage characteristics is promoted due to an increased amount of decomposition of the CAE in the positive electrode.

According to the new finding of the present disclosure, when Li₃PO₄ is added to the positive electrode composite material and the volume fraction of the CAE in the electrolyte solution is 20% or more, it is expected to reduce decreased storage characteristics resulting from the increased CAE. When the amount of the CAE, which is likely to undergo oxidation decomposition, is more than or equal to the specific amount, reaction between the CAE and Li₃PO₄ can be promoted at a surface of the positive electrode active material. It is considered that a stable protective film is promptly formed by the reaction. It is expected that the oxidation decomposition of the CAE is reduced after the formation of the protective film. That is, it is expected that the decrease of the storage characteristics is reduced.

2. The lithium ion battery according to “1” may have, for example, the following configuration. The positive electrode may be configured to have a potential of 4.5 V (vs. Li/Li+) or less when fully charged.

Conventionally, it has been confirmed that a protective film of Li₃PO₄ is formed at a high potential exceeding 4.5 V (vs. Li/Li+). According to the new finding of the present disclosure, when the volume fraction of the CAE is 20% or more, a stable protective film can be formed at a positive electrode potential of 4.5 V (vs. Li/Li⁺) or less. Thus, it is expected to further reduce the decrease of the storage characteristics.

3. The lithium ion battery according to “1” or “2” may have, for example, the following configuration. The carboxylic acid ester is at least one selected from a group consisting of methyl propionate and methyl acetate.

4. The lithium ion battery according to any one of “1” to “3” may have, for example, the following configuration. A mass fraction of Li₃PO₄ with respect to a sum of the positive electrode active material and Li₃PO₄ is 1 to 10%. The solvent includes 20 to 70% of the carboxylic acid ester in volume fraction.

5. A lithium ion battery according to one aspect of the present disclosure may have the following configuration. The lithium ion battery includes a positive electrode, a negative electrode, and an electrolyte solution. The positive electrode includes a positive electrode composite material. The positive electrode composite material includes a positive electrode active material and Li₃PO₄. A mass fraction of Li₃PO₄ with respect to a sum of the positive electrode active material and Li₃PO₄ is 1 to 10%. The electrolyte solution includes a lithium salt and a solvent. The solvent includes 20 to 70% of the carboxylic acid ester in volume fraction. The positive electrode is configured to have a potential of 4.5 V (vs. Li/Li⁺) or less when fully charged.

Hereinafter, an embodiment (hereinafter, also simply referred to as “the present embodiment”) of the present disclosure will be described. It should be noted that the present embodiment does not limit the technical scope of the present disclosure. The present embodiment is illustrative in any respect. The present embodiment is non-restrictive. The technical scope of the present disclosure includes any modifications within the scope and meaning equivalent to the terms of the claims. For example, it is initially expected to extract freely configurations from the present embodiment and combine them freely.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a conceptual diagram showing an example of a lithium ion battery according to the present embodiment.

FIG. 2 is a table 1 showing experimental results.

FIG. 3 is a graph showing the relationship between the volume fraction of CAE and the remaining capacity.

FIG. 4 is a graph showing the relationship between the volume fraction of CAE and the amount of generated gas.

### DESCRIPTION OF THE PREFERRED EMBODIMENTS

### —Terms and Phrases—

The stoichiometric formula represents a representative example of a compound. The compound may have a non-stoichiometric composition. For example, “Li₃PO₄” is not limited to a compound having an amount-of-substance ratio (molar ratio) of “Li/P/O=3/1/4”. “Li₃PO₄” refers to a compound containing Li, P, and O in any molar ratio unless otherwise specified. For example, the compound may be doped with a trace element. A part of Li, P and O may be substituted with another element.

“Carboxylic acid ester (CAE)” refers to a compound derived by condensation of a carboxylic acid with an alcohol. Carboxylic acid esters are distinguished from carbonic acid esters (carbonates).

“Full charging” indicates charging until the active material that can react returns to the state before discharging. Full charging may be paraphrased as “complete charging”, “charging level of 100%”, or “state of charge (SOC) of 100%”.

“V (vs. Li/Li⁺)” indicates a potential based on lithium (Li) metal (zero).

Numerical ranges such as “m to n %” include upper and lower limits unless otherwise specified. That is, “m to n %” indicates a numerical range of “m % or more and n % or less”. The term “m % or more and n % or less” includes “more than m % and less than n %”. The expressions “or more” and “or less” are represented by an inequality sign “≤” with an equal sign. The expressions “more than” and “less than” are represented by an inequality sign “<” that does not include an equal sign. A numerical value freely selected from the numerical range may be set as a new upper limit value or lower limit value. For example, a new numerical value range may be set by freely combining a numerical value within the numerical value range with a numerical value described in another part, a table, a drawing, or the like in the present specification.

### —Lithium Ion Battery—

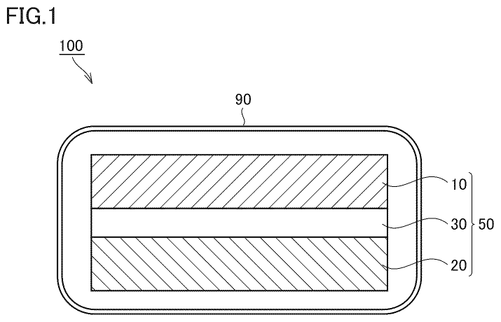

FIG. 1 is a conceptual diagram showing an example of a lithium ion battery according to the present embodiment. The battery 100 includes a power generation element 50 and an exterior package 90. The exterior package 90 is sealed. The exterior package 90 may be, for example, a metal case, a pouch made of a metal foil laminate film, or the like. The exterior package 90 houses the power generation element 50 and an electrolyte solution (not shown).

### —Electrolyte Solution—

The electrolyte solution is a liquid electrolyte. The electrolyte solution includes a Li salt and a solvent. The Li salt is dissolved in the solvent. The concentration of the Li salt may be, for example, 0.5 to 2 mol/L or 1 to 1.5 mol/L. The Li salt may be, for example, at least one selected from the group consisting of LiPF₆, LiBF₄, LiClO₄, LIN(SO₂F)₂ “LiFSI”, and LiN(SO₂CF₃)₂ “LiTFSI”.

The solvent comprises 20% or more of CAE in volume fraction. The solvent may consist of, for example, 20% or more of CAE in volume fraction and the remainder of carbonate. The volume fraction of CAE may be, for example, 40% or more, 50% or more, 60% or more, 70% or more, 80% or more, or 90% or more. The volume fraction of CAE may be, for example, 100% or less, 90% or less, 80% or less, 70% or less, 60% or less, 50% or less, or 40% or less.

The CAE may be, for example, at least one selected from the group consisting of methyl formate (MF), methyl acetate (MA), methyl propionate (MP), and diethyl malonate (DEM). The CAE may comprise, for example, at least one selected from the group consisting of MP and MA.

The carbonate may include, for example, at least one selected from the group consisting of a cyclic carbonate and a chain carbonate. The cyclic carbonate may include, for example, at least one selected from the group consisting of ethylene carbonate (EC), propylene carbonate (PC), butylene carbonate (BC), and monofluoroethylene carbonate (FEC). The chain carbonate may include, for example, at least one selected from the group consisting of dimethyl carbonate (DMC), diethyl carbonate (DEC), and ethyl methyl carbonate (EMC).

The solvent may satisfy the following relationship, for example.

$$Va + Vb + Vc = 100 \%$$

20%≤Va≤40%, 0%≤Vb≤50%, 20%≤Vc≤70%
Va: volume fraction of cyclic carbonate
Vb: volume fraction of chain carbonate
Vc: volume fraction of CAE

The electrolyte solution may further contain an optional additive in addition to the Li salt and the solvent. The addition amount (mass fraction with respect to the entire electrolyte solution) may be, for example, 0.01 to 5% or 0.1 to 1%. The additive may include, for example, vinylene carbonate (VC), LiB(C₂O₄)₂ “LiBOB”, or the like.

### —Power Generation Element—

The power generation element 50 may also be referred to as, for example, an “electrode assembly”. The power generation element 50 includes a positive electrode 10 and a negative electrode 20. The power generation element 50 may further include a separator 30. The power generation element 50 may have any form. The power generation element 50 may be, for example, a wound type or a stacked type.

### —Positive Electrode—

The positive electrode 10 may be in the form of a sheet, for example. The positive electrode 10 may include, for example, a positive electrode current collector and a positive electrode composite material layer. The positive electrode current collector supports the positive electrode composite material layer. The positive electrode current collector may include, for example, an aluminum (Al) foil or the like. The positive electrode composite material layer may be formed of a positive electrode composite material. The positive electrode composite material includes a positive electrode active material and Li₃PO₄. The mass fraction of Li₃PO₄ with respect to the sum of the positive electrode active material and Li₃PO₄ may be, for example, 1 to 10%. The mass fraction of Li₃PO₄ may be, for example, 2% or more, 3% or more, 4% or more, 5% or more, 6% or more, 7% or more, 8% or more, or 9% or more. The mass fraction of Li₃PO₄ may be, for example, 9% or less, 8% or less, 7% or less, 6% or less, 5% or less, 4% or less, 3% or less, or 2% or less.

The positive electrode active material may be, for example, a particle group (powder). The D50 of the positive electrode active material may be, for example, 1 to 30 μm, or 5 to 15 μm. “D50” indicates the particle size at which the integration is 50% in the volume-based particle size distribution (integrated distribution). The particle size distribution may be measured by laser diffraction. The positive electrode active material may contain an optional component. The positive electrode active material may include, for example, at least one selected from the group consisting of LiCoO₂, LiNiO₂, LiMnO₂, LiMn₂O₄, Li(NiCoMn) O₂, Li(NiCoAl)O₂, and LiFePO₄. For example, “(NiCoMn)” in “Li(NiCoMn)O₂” indicates that the total composition ratio in parentheses is 1. The amount of individual ingredients is freely set as long as the total is 1. Li(NiCoMn)O₂ may contain, for example, LiNi_{1/3}CO_{1/3}Mn_{1/3}O₂, LiNi_{0.5}CO_{0.2}Mn_{0.3}O₂, LiNi_{0.8}CO_{0.1}Mn_{0.1}O₂, or the like. Hereinafter, LiNi_{1/3}CO_{1/3}Mn_{1/3}O₂ may be abbreviated as “NCM”.

The battery 100 may be configured such that the positive electrode 10 has a potential of 4.5 V (vs. Li/Li⁺) or less when fully charged. The positive electrode potential at the time of complete charging may be, for example, 4.4 V (vs. Li/Li⁺) or less, or 4.3 V (vs. Li/Li⁺) or less. The positive electrode potential at the time of complete charging may be, for example, 4.2 V (vs. Li/Li⁺) or more, or 4.3 V (vs. Li/Li⁺) or more.

In addition to the positive electrode active material and Li₃PO₄, the positive electrode composite material may further contain, for example, a conductive material and a binder. The conductive material may include, for example, at least one selected from the group consisting of carbon black (CB), vapor-grown carbon fibers, carbon nanotubes, and graphene flakes. The blending amount of the conductive material may be, for example, 0.1 to 10 parts by mass with respect to 100 parts by mass of the positive electrode active material.

The binder may include, for example, at least one selected from the group consisting of polyvinylidene difluoride (PVdF), polytetrafluoroethylene (PTFE), vinylidene difluoride-hexafluoropropylene copolymer (PVdF-HFP), and polyacrylic acid (PAA). The blending amount of the binder may be, for example, 0.1 to 10 parts by mass with respect to 100 parts by mass of the positive electrode active material.

### —Negative Electrode—

The negative electrode 20 may be in the form of a sheet, for example. The negative electrode 20 may include, for example, a negative electrode current collector and a negative electrode composite material layer. The negative electrode current collector supports the negative electrode composite material layer. The negative electrode current collector may include, for example, a copper (Cu) foil or the like. The negative electrode composite material layer may be formed of a negative electrode composite material. The negative electrode composite material includes a negative electrode active material. The negative electrode active material may be, for example, a particle group. The D50 of the negative electrode active material may be, for example, 1 to 30 μm, or 5 to 15 μm. The negative electrode active material may contain an optional component. The negative electrode active material may contain, for example, at least one selected from the group consisting of natural graphite, artificial graphite, soft carbon, hard carbon, silicon (Si), silicon oxide (SiO), Si-based alloy, Si—C composite material, tin, tin oxide, and lithium titanate. The “Si—C composite material” may include, for example, composite particles. The composite particles may include, for example, porous carbon particles. Si particles may be supported in the pores of the porous carbon particles.

The negative electrode composite material may further contain, for example, a binder in addition to the negative electrode active material. The binder may include, for example, at least one selected from the group consisting of styrene-butadiene rubber (SBR), carboxymethyl cellulose (CMC), polyimide (PI), and polyamide-imide (PAI). The blending amount of the binder may be, for example, 0.1 to 10 parts by mass with respect to 100 parts by mass of the negative electrode active material.

### —Separator—

The separator 30 is disposed between the positive electrode 10 and the negative electrode 20. The separator 30 separates the positive electrode 10 from the negative electrode 20. The separator 30 may include, for example, a porous film or the like. Separator 30 may have a Gurley value of, for example, 200 to 400 sec/100 mL. The Gurley value may be measured by a Gurley test method. The separator 30 may have, for example, a multilayer structure. The multilayer structure may be formed by stacking a polypropylene (PP) layer, a polyethylene (PE) layer, and a PP layer in this order, for example.

### EXAMPLES

### —Production of Test Cell—

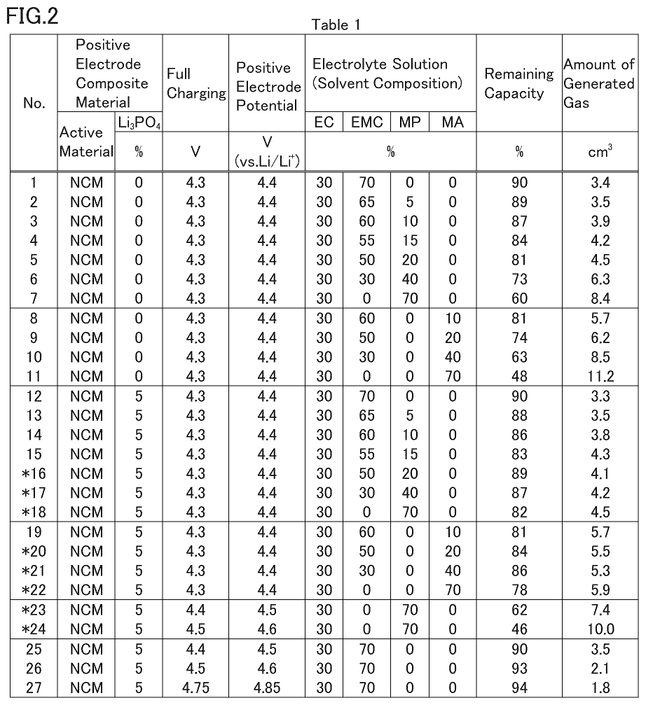

FIG. 2 is a table 1 showing experimental results. Cells (lithium ion batteries) according to Nos. 1 to 27 were produced by the following procedure.

### Production of Positive Electrode

The following materials were prepared:
Positive Electrode Active Material: NCM
Conductive Material: CB
Binder: PVdF
Dispersion Medium: N-methyl-2-pyrrolidone (NMP)
Positive Electrode Current Collector: Al foil

The slurry was prepared by mixing NCM, CB, Li₃PO₄, PVdF and NMP. The blending ratio of the solid content was “NCM/CB/PVdF=87/10/3 (mass ratio)”. The blending amount (mass fraction) of Li₃PO₄ was 5% with respect to the total of NCM and Li₃PO₄. The slurry was applied to the surface of the positive electrode current collector to form a positive electrode composite material layer. The positive electrode composite material layer was compressed to produce a positive electrode.

### Production of Negative Electrode

The following materials were prepared:
Negative Electrode Active Material: natural graphite (D50=20 μm)
Binder: SBR, CMC
Dispersion Medium: water
Negative Electrode Current Collector: Cu foil

The slurry was prepared by mixing graphite, CMC, SBR, and water. The blending ratio of the solid content was “graphite/CMC/SBR=98/1/1 (mass ratio)”. The slurry was applied to the surface of the negative electrode current collector to form a negative electrode composite material layer. The coating weight of the negative electrode composite material layer was adjusted so that the ratio of the negative electrode capacity to the positive electrode capacity was 1.1. The negative electrode composite material layer was compressed to produce a negative electrode.

### Assembling

The following materials were prepared:
Separator: three-layer structure (PP layer/PE layer/PP layer), Gurley value=300 seconds/100 mL
Exterior Package: pouch made of Al laminate film
Electrolyte Solution: LiPF₆ (concentration=1 mol/L), solvent composition (see FIG. 2)

A power generation element was formed by stacking the positive electrode, the separator, and the negative electrode. The power generation element was housed in the exterior package. The electrolyte solution was injected into the exterior package. After the electrolyte solution was injected, the exterior package was sealed, so that the cell was manufactured.

### Activation Process

In a thermostatic chamber (setting temperature: 25° C.), the following cycle of constant current charging and constant current discharging was repeated three times. “C” is a symbol representing the time rate of the current. With the current of 1 C, the rated capacity of the cell is discharged in one hour.
Constant Current Charging: current=0.1 C, cut voltage=4.3 V
Constant Current Discharge: current=0.3 C, cut voltage=3 V

### Measurement of Capacity

The initial capacity (initial discharge capacity) was measured by the following constant current-constant voltage charge and constant current discharge.
Constant Current-Voltage Charging: current=0.1 C, upper limit voltage=4.3, cut current=0.02 C
Constant Current Discharge: current=0.2 C, cut voltage=3 V

### —Storage Test—

The initial volume of the cell was measured by Archimedes' method. The voltage of the cell was adjusted to 4.3 V by constant current-constant voltage charging (current=0.1 C, upper limit voltage=4.3 V) in a thermostatic chamber (setting temperature: 25° C.). After the voltage was adjusted, the cell was allowed to stand for 100 days in a thermostatic chamber (setting temperature: 60° C.). After 100 days, the cells were discharged by constant current discharge (current=0.2 C, cut voltage=3 V) in a thermostatic chamber (setting temperature: 25° C.), and the remaining capacity was measured. The value of the item “remaining capacity” in FIG. 2 (Table 1) is the percentage of the remaining capacity with respect to the initial capacity. It is considered that the larger the remaining capacity is, the less the decrease of the storage characteristics is.

After discharge, the post-storage volume of the cell was measured by Archimedes' method. The amount of generated gas was measured by subtracting the initial volume from the post-storage volume. It is considered that the smaller the amount of generated gas is, the less the decrease of the storage characteristics is.

### —Results—

In FIG. 2 (Table 1), the cells satisfying the following conditions (A) and (B) tend to exhibit a small decrease in storage characteristics. In the table, “*” marks are attached to “No.” of cells satisfying the following conditions (A) and (B) such as “No.*16”.

(A) The volume fraction of CAE (MP, MA) in the electrolyte solution (solvent) is 20% or more.

(B) The positive electrode composite material includes a positive electrode active material and Li₃PO₄.

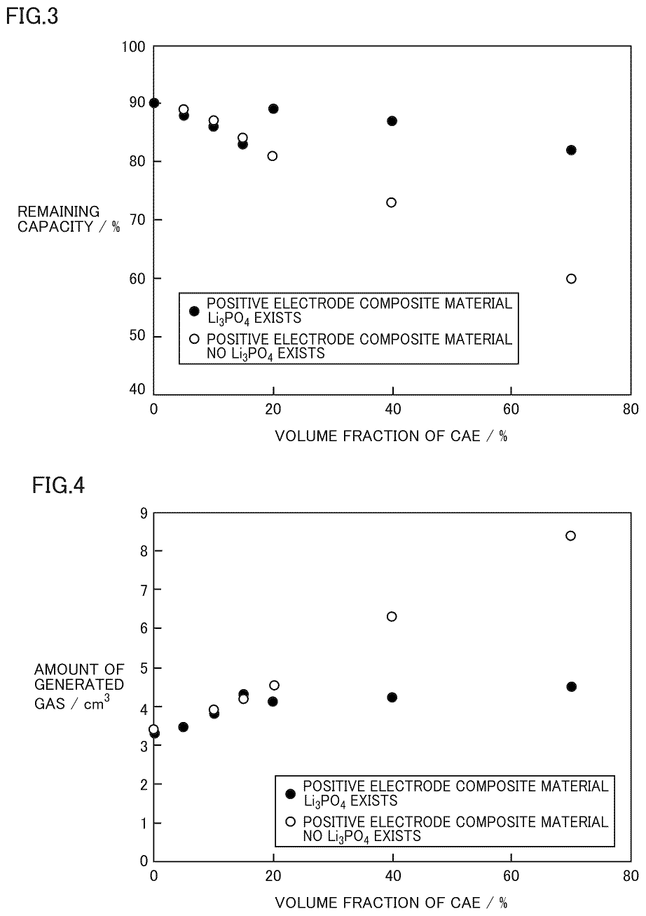

FIG. 3 is a graph showing the relationship between the volume fraction of CAE and the remaining capacity. When Li₃PO₄ is not added to the positive electrode composite material, the remaining capacity tends to monotonously decrease as the volume fraction of CAE increases. FIG. 4 is a graph showing the relationship between the volume fraction of CAE and the amount of generated gas. When Li₃PO₄ is not added to the positive electrode composite material, the amount of generated gas tends to monotonously increase as the volume fraction of CAE increases.

In FIG. 3 and FIG. 4, when Li₃PO₄ is added to the positive electrode composite material, the behavior of decrease of the storage characteristics is changed with respect to the volume fraction of 20%. That is, at a volume fraction of 20%, there is a tendency that the behavior of decrease of the storage characteristics is once reversed and then becomes gentle. At a volume fraction of 20% or more, it is considered that the decrease of the storage characteristics is reduced.

In FIG. 2 (Table 1), the value of the item “positive electrode potential” indicates the positive electrode potential at the time of complete charging. From the results of Nos. 1, 12, 25, 26, and 27, when the solvent is composed of carbonate (EC/EMC=30/70), there is a tendency that the effect of adding Li₃PO₄ becomes remarkable in a range in which the positive electrode potential is more than 4.5 V (vs. Li/Li⁺).

From the results of No. 7, No. *18, No. *23, and No. *24, when the solvent contains CAE (MP), the effect of adding Li₃PO₄ tends to be remarkable in a range in which the positive electrode potential is 4.5 V (vs. Li/Li⁺) or less.

What is claimed is:

1. A lithium ion battery comprising:
a positive electrode;
a negative electrode; and
an electrolyte solution, wherein
the positive electrode includes a positive electrode composite material, the positive electrode composite material includes a positive electrode active material and Li₃PO₄,
the electrolyte solution includes a lithium salt and a solvent, and
the solvent includes 20% or more of a carboxylic acid ester in volume fraction.

2. The lithium ion battery according to claim 1, wherein the positive electrode is configured to have a potential of 4.5 V (vs. Li/Li⁺) or less when fully charged.

3. The lithium ion battery according to claim 1, wherein the carboxylic acid ester is at least one selected from a group consisting of methyl propionate and methyl acetate.

4. The lithium ion battery according to claim 1, wherein a mass fraction of Li₃PO₄ with respect to a sum of the positive electrode active material and Li₃PO₄ is 1 to 10%, and
the solvent includes 20 to 70% of the carboxylic acid ester in volume fraction.

5. A lithium ion battery comprising:
a positive electrode;
a negative electrode; and
an electrolyte solution, wherein
the positive electrode includes a positive electrode composite material,
the positive electrode composite material includes a positive electrode active material and Li₃PO₄,
a mass fraction of Li₃PO₄ with respect to a sum of the positive electrode active material and Li₃PO₄ is 1 to 10%,
the electrolyte solution includes a lithium salt and a solvent,
the solvent includes 20 to 70% of a carboxylic acid ester in volume fraction, and
the positive electrode is configured to have a potential of 4.5 V (vs. Li/Li⁺) or less when fully charged.
